(19) United States
(12) Patent Application Publication
(10) Pub. No.: US 2019/0279145 A1
(43) Pub. Date: Sep. 12, 2019

(54) PRODUCT LINEUP RECOMMENDATION DEVICE, PRODUCT LINEUP RECOMMENDATION METHOD, AND PRODUCT LINEUP RECOMMENDATION PROGRAM

(71) Applicant: NEC CORPORATION, Tokyo (JP)

(72) Inventors: Takayuki NAKANO, Tokyo (JP); Yuuki KUBOTA, Tokyo (JP)

(73) Assignee: NEC CORPORATION, Tokyo (JP)

(21) Appl. No.: 16/335,094

(22) PCT Filed: Sep. 15, 2017
(86) PCT No.: PCT/JP2017/033552

§ 371 Date: Mar. 20, 2019

(30) Foreign Application Priority Data
Sep. 21, 2016 (JP) 2016-183725

(51) Int. Cl. G06Q 10/08; G06Q 30/02

(52) U.S. Cl. CPC G06Q 10/087; G06Q 30/0201

(57) ABSTRACT

A first configuration information calculation unit 61 calculates, on the basis of sales results for a target store during a predetermined past period, first configuration information, which is sales monetary amount configuration information for products having sales results at the target store. A second configuration information calculation unit 62 calculates second configuration information, which is sales monetary amount configuration information for products having no sales results at the target store during the period on the basis of a prediction model that predicts sales monetary amount configuration information for single product items. A product selection unit 63 selects a specified number of products from among products for which the first configuration information is calculated and products for which the second configuration information is calculated, in descending order of monetary amount indicated by the sales monetary amount configuration information.

### TECHNICAL FIELD

The present invention relates to a product lineup recommendation device, a product lineup recommendation method, and a product lineup recommendation program for determining a recommended product lineup.

### BACKGROUND ART

In a business form in which a large number of stores are managed on the headquarters side, the number of stock keeping units (SKUs) for each store is periodically determined depending on the store size as an operation in order to increase the sales through inventory management of appropriate products. In addition, a product lineup recommended for each store is determined on the headquarters side as an operation to enable the product lineup to be used as guidelines for ordering.

Patent Literature (PTL) 1 describes a product automatic ordering device that calculates a reference value for a product having no sales results or the like and places an order by an appropriate order quantity. The device described in PTL 1 considers a regular product having no sales results as a new product and revises the reference value corresponding to the new product on the basis of inventory information stored in an inventory information file.

### CITATION LIST

### Patent Literature

PTL 1: Japanese Patent Application Laid-Open No. 2006-127062

### SUMMARY OF INVENTION

### Technical Problem

In order to increase the sales at the entire store, it is preferable that products expected to be sold well are able to be recommended for the product lineup. If, however, an attempt to determine a product lineup on the basis of only past sales results causes a problem that products having no sales results during a target period, such as products temporarily out-of-stock, back-ordered products, or products continued to be out of stock, are removed from the recommended product lineup.

Furthermore, the device described in PTL 1 adopts the reference values to determine the order quantity of products having sales results and the order quantity of products having no sales results. Due to an unclear relationship between the products having sales results and products having no sales results in reference values calculated therefor, however, it is difficult to determine which products should be prioritized for the product lineup even if the reference values are used, problematically.

Therefore, it is an object of the present invention to provide a product lineup recommendation device, a product lineup recommendation method, and a product lineup recommendation program capable of recommending product lineup targets with an order of priority set for products having no sales results, independently of presence or absence of sales results.

### Solution to Problem

A product lineup recommendation device according to an aspect of the present invention including: a first configuration information calculation unit that calculates, on the basis of sales results for a target store during a predetermined past period, first configuration information, which is sales monetary amount configuration information for products having sales results at the target store; a second configuration information calculation unit that calculates second configuration information, which is sales monetary amount configuration information for products having no sales results at the target store during the period on the basis of a prediction model that predicts sales monetary amount configuration information for single product items; and a product selection unit that selects a specified number of products from among products for which the first configuration information is calculated and products for which the second configuration information is calculated, in descending order of monetary amount indicated by the sales monetary amount configuration information.

A product lineup recommendation method according to another aspect of the present invention including the steps of: calculating, on the basis of sales results for a target store during a predetermined past period, first configuration information, which is sales monetary amount configuration information for products having sales results at the target store; calculating second configuration information, which is sales monetary amount configuration information for products having no sales results at the target store during the period on the basis of a prediction model that predicts sales monetary amount configuration information for single product items; and selecting a specified number of products from among products for which the first configuration information is calculated and products for which the second configuration information is calculated, in descending order of monetary amount indicated by the sales monetary amount configuration information.

A product lineup recommendation program according still another aspect of the present invention, causing a computer to perform: first configuration information calculation processing of calculating, on the basis of sales results for a target store during a predetermined past period, first configuration information, which is sales monetary amount configuration information for products having sales results at the target store; second configuration information calculation processing of calculating second configuration information, which is sales monetary amount configuration information for products having no sales results at the target store during the period on the basis of a prediction model that predicts sales monetary amount configuration information for single product items; and product selection processing of selecting a specified number of products from among products for which the first configuration information is calculated and products for which the second configuration information is calculated, in descending order of monetary amount indicated by the sales monetary amount configuration information.

### Advantageous Effects of Invention

According to the present invention, product lineup targets are able to be recommended independently of the presence or absence of the sales results, with prioritized products having no sales results.

### BRIEF DESCRIPTION OF DRAWINGS

FIG. 1 is a block diagram illustrating an exemplary embodiment of an inventory management system according to the present invention.

FIG. 2 is an explanatory diagram illustrating an example of the timing at which product lineup recommendation processing is performed.

FIG. 3 is an explanatory diagram illustrating an example of an orderable product list.

FIG. 4 is an explanatory diagram illustrating an example of processing of correcting a recommended number of SKUs.

FIG. 5 is an explanatory diagram illustrating another example of processing of correcting the recommended number of SKUs.

FIG. 6 is an explanatory diagram illustrating an example of processing of calculating the recommended number of SKUs for each product lineup section.

FIG. 7 is an explanatory diagram illustrating an example of processing of calculating a new product score.

FIG. 8 is an explanatory diagram illustrating an example of a calculation result of a sales trend score.

FIG. 9 is an explanatory diagram illustrating an example of a method of determining a repeat user.

FIG. 10 is an explanatory diagram illustrating an example of processing of identifying a repeat user.

FIG. 11 is an explanatory diagram illustrating an example in which calculated repeat scores are associated with the sales scores of existing products.

FIG. 12 is an explanatory diagram illustrating an example of processing of selecting sales order products.

FIG. 13 is an explanatory diagram illustrating an example of processing of selecting repetition order products.

FIG. 14 is a sequence diagram illustrating an example of action of an inventory management system.

FIG. 15 is a flowchart illustrating an example of processing of correcting the number of SKUs calculated according to a variability rate of demand prediction.

FIG. 16 is a flowchart illustrating an example of action of determining a recommended product lineup.

FIG. 17 is a block diagram illustrating an outline of a server according to the present invention.

### DESCRIPTION OF EMBODIMENT

Hereinafter, an exemplary embodiment of the present invention will be described with reference to appended drawings.

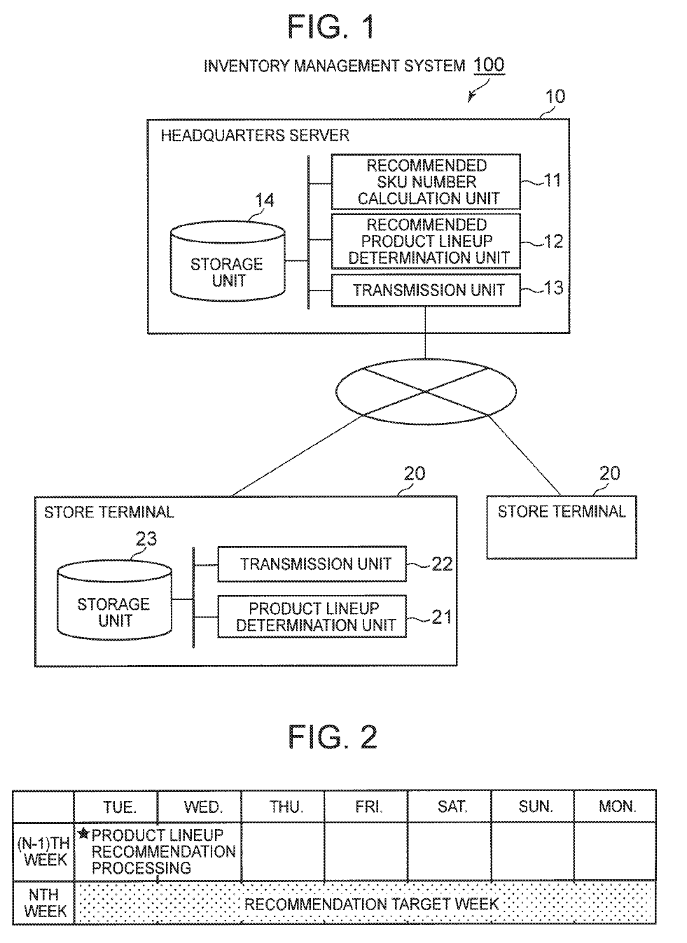

FIG. 1 is a block diagram illustrating an exemplary embodiment of an inventory management system according to the present invention. An inventory management system 100 of this exemplary embodiment includes a headquarters server 10 and a store terminal 20. The headquarters server 10 is a device used on the headquarters side managing respective stores. Moreover, the store terminal 20 is a device used in each store managed by the headquarters. Although two store terminals 20 are illustrated in FIG. 1, the number of store terminals 20 is not limited to two, but may be one, or may be three or more.

The headquarters server 10 determines the number of SKUs for each category recommended (hereinafter, referred to as “recommended number of SKUs”) for each store and a recommended product lineup in response to a headquarters' instruction. In this exemplary embodiment, the headquarters server 10 determines the recommended number of SKUs and the recommended product lineup for each category every week and then transmits them to the store terminal 20. Since the headquarters server 10 manages the inventory of each store, the headquarters server 10 may be also referred to as “inventory management server.” In addition, since recommending a lineup of products, the headquarters server 10 may also be referred to as “product lineup recommendation device.”

Moreover, each store uses the store terminal 20 to fix the product lineup and the number of SKUs for each category finally adopted by each store (hereinafter, the number of SKUs is referred to as “adopted number of SKUs”) with consideration for the recommended number of SKUs and the recommended product lineup. The target products for lineup are previously classified into categories by property or the like.

In addition, considering the time to order placement and the like, the product lineup recommendation processing is performed in a week immediately before a recommendation target week. FIG. 2 is an explanatory diagram illustrating an example of the timing at which product lineup recommendation processing is performed. For example, in the case where a unit for the recommendation target week ranges from Tuesday to Monday as illustrated in FIG. 2, the product lineup recommendation processing is performed, for example, on Tuesday in the previous week. In the following description, the recommendation target week is referred to as “Nth week.” Moreover, a week previous to the recommendation target week is referred to as “(N−1)th week.” Similarly, the weeks subsequent to the recommendation target week are referred to as “(N+1)th week,” “(N+2)th week,” and the like.

Although the following description is made assuming that a target period (unit) during which the recommended number of SKUs is calculated is one week, the period (unit) is not limited to one week, but may be, for example, one day (24 hours).

Referring to FIG. 1, the headquarters server 10 includes a recommended SKU number calculation unit 11, a recommended product lineup determination unit 12, a transmission unit 13, and a storage unit 14.

The storage unit 14 stores various data used for calculating the recommended number of SKUs and for determining the recommended product lineup. The storage unit 14 stores, for example, sales results or a product master of a product, a product on which emphasis is put for management, measure information, and the like. The storage unit 14 is implemented by a magnetic disk or the like. Incidentally, the storage unit 14 may be included in a device (not illustrated) other than the headquarters server 10 connected through a communication network.

The recommended SKU number calculation unit 11 creates an orderable product list in the recommendation target week. The method of creating the orderable product list is arbitrary. The recommended SKU number calculation unit 11 may create the orderable product list by listing all products orderable in the recommendation target week or may create the orderable product list by intentionally removing some products.

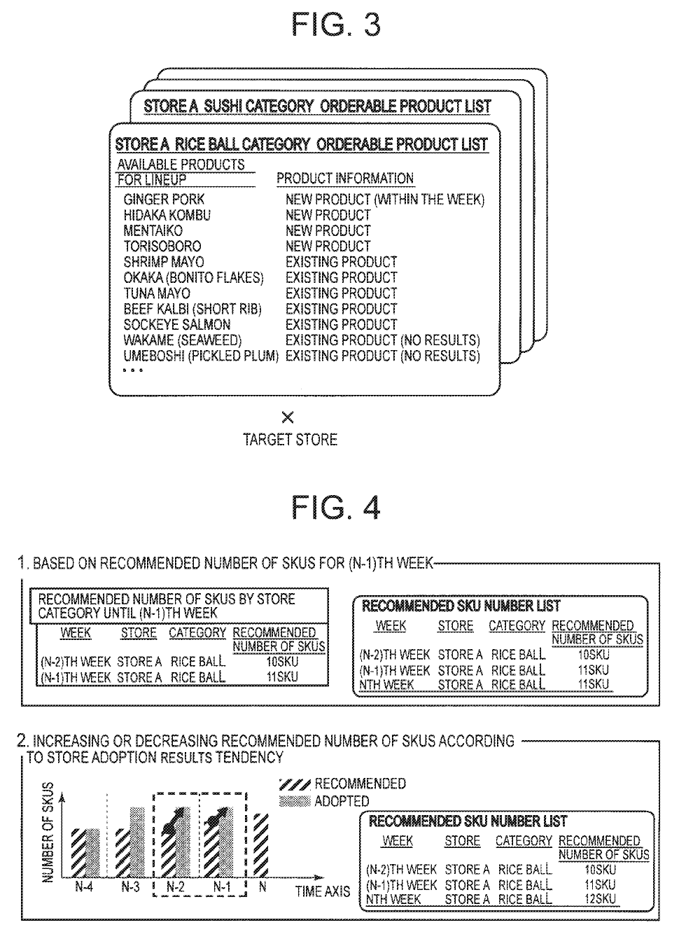

FIG. 3 is an explanatory diagram illustrating an example of an orderable product list. In the example illustrated in FIG. 3, an orderable product list is generated for each category (rice ball category, sushi category) of each store. The orderable product list may include information on the products (for example, new product, existing product, and the like) along with orderable (available for lineup) products.

The recommended SKU number calculation unit 11 calculates the recommended number of SKUs by category of each store. First, the recommended SKU number calculation unit 11 calculates the recommended SKUs for each store on the basis of the number of SKUs recommended in the past. Specifically, the recommended SKU number calculation unit 11 acquires the recommended number of SKUs for each category of each store in the (N−1)th week stored in the storage unit 14 and then sets the number as a reference to the recommended number of SKUs. In the case of a store not having the number of SKUs recommended in the past (for example, in the case where there is no recommended number of SKUs for the (N−1)th week), the recommended SKU number calculation unit 11 may determine the recommended number of SKUs in the (N−1)th week of a store similar in size and locational conditions or the like to the store as a reference.

The viewpoints for deciding whether or not the store is similar in size include, for example, a store floor area, the number of products handled, an area of a parking lot, an area of a storage room, the number of employees, and the like. If the contents thereof are within a predetermined range, the recommended SKU number calculation unit 11 may decide that the store is a similar store.

Furthermore, the viewpoints for deciding whether or not the store is similar in locational conditions include, for example, a distance from a station and a situation of a facing road (the number of lanes, a traffic volume, or the like), a business district or a residential area, the presence or absence of a parking space, the number of neighboring competing stores, and the like. The recommended SKU number calculation unit 11 may decide whether the store is a similar store by deciding whether these contents coincide with predetermined conditions and whether the coincident conditions are within a predetermined range.

Subsequently, the recommended SKU number calculation unit 11 acquires an actual value of the adopted number of SKUs by category for each store until the (N−1)th week. Specifically, the recommended SKU number calculation unit 11 acquires the adopted number of SKUs sent back in response to the transmitted recommended number of SKUs. The actual value of the adopted number of SKUs by category for each store is transmitted at a predetermined timing from the store terminal 20 to the headquarters server 10 and then stored in the storage unit 14.

In the case where the adopted number of SKUs sent back in response to the transmitted recommended number of SKUs changes continuously and in a consistent trend, the recommended SKU number calculation unit 11 changes the recommended number of SKUs in accordance with the trend. Specifically, in the case where the adopted number of SKUs, which has been sent back from the store terminal in response to the transmitted recommended number of SKUs, increased at least twice continuously, the recommended SKU number calculation unit 11 increases the recommended number of SKUs for the store. On the other hand, in the case where the adopted number of SKUs, which has been sent back from the store terminal in response to the transmitted recommended number of SKUs, decreased at least twice continuously, the recommended SKU number calculation unit 11 decreases the recommended number of SKUs for the store.

For example, in the case where the adopted number of SKUs of the category was changed to increase at least twice continuously with respect to the recommended number of SKUs, the recommended SKU number calculation unit 11 corrects the recommended number of SKUs of the category for the store used for a reference so as to be increased. On the other hand, in the case where the adopted number of SKUs of the category was changed to decrease at least twice continuously with respect to the recommended number of SKUs, the recommended SKU number calculation unit 11 corrects the recommended number of SKUs of the category for the store used for a reference so as to be decreased.

The method of determining the number of SKUs to be increased or decreased is arbitrary. The recommended SKU number calculation unit 11 may correct the recommended number of SKUs according to a predetermined number or rate (a rate of change or a rate of decrease), for example, independently of a difference between the recommended number of SKUs and the adopted number of SKUs. Moreover, the number of times for determining the continuous increase or decrease is not limited to twice, but may be three or more times.

FIG. 4 is an explanatory diagram illustrating an example of processing of correcting a recommended number of SKUs. First, the recommended SKU number calculation unit 11 determines the number of SKUs of the Nth week from the recommended number of SKUs by store category of the (N−1)th week. In the example illustrated in FIG. 4, the recommended number of SKUs by store category of the (N−1)th week is 11, and therefore the recommended number of SKUs of the Nth week used as a base is determined to be 11.

The recommended SKU number calculation unit 11 then increases or decreases the recommended number of SKUs according to a store adoption results tendency. In the example illustrated in FIG. 4, the recommended number of SKUs is changed to increase the adopted number of SKUs by comparison with the recommended number of SKUs by store category of the (N−2)th week and that of the (N−1)th week. Therefore, the recommended SKU number calculation unit 11 increments the recommended number of SKUs of the Nth week by one.

Since the recommended SKU number calculation unit 11 corrects the recommended number of SKUs on the basis of the store adoption results tendency in this manner, the manipulations of correcting the adopted number of SKUs on the basis of the recommended number of SKUs on the store side is able to be reduced.

Furthermore, in the case where the degree of variation in demand prediction exceeds a predetermined threshold value, the recommended SKU number calculation unit 11 corrects the recommended number of SKUs in accordance with the degree. Specifically, in the case where the degree of variation obtained by comparing the demand prediction number of the Nth week (hereinafter, referred to as “first demand prediction”) with the demand prediction number of the (N+1)th week (hereinafter, referred to as “second demand prediction”) exceeds a predetermined threshold value, the recommended SKU number calculation unit 11 increases or decreases the predetermined recommended number of SKUs in accordance with the varying direction (the increasing or decreasing direction) and the degree thereof. In other words, if a degree of variation in the second demand prediction relative to the first demand prediction exceeds the threshold value, the recommended SKU number calculation unit 11 corrects the calculated number of SKUs in accordance with the degree.

In the following description, a variability rate will be described as an example of the degree of variation. The value of the degree of variation used in this exemplary embodiment is not limited to the variability rate as long as the level of change in demand prediction can be measured. For example, the difference between the first and second demand predictions may be used as the degree of variation.

Specifically, in the case where the degree of increase in the second demand prediction relative to the first demand prediction exceeds a threshold value (hereinafter, referred to as “first threshold value”), the recommended SKU number calculation unit 11 revises the calculated recommended number of SKUs so as to increase. On the other hand, in the case where the degree of decrease in the second demand prediction relative to the first demand prediction exceeds a threshold value (hereinafter, referred to as “second threshold value”), the recommended SKU number calculation unit 11 revises the calculated recommended number of SKUs so as to decrease.

The demand prediction number is calculated by using a prediction model for predicting the number of demands for each store and for each category. The content of the prediction model and a learning method are arbitrary. For example, data of sales results, weather forecasts, prediction of the number of customers, and the like are used for learning. The variability rate indicating an example of the degree of variation is calculated by using the following equation 1, for example.

Variability rate=(Demand prediction number of (N+1)th week−Demand prediction number of Nth week)÷Demand prediction number of Nth week (Equation 1)

Moreover, the recommended SKU number calculation unit 11 receives the adopted number of SKUs sent back from the store terminal 20 for the calculated recommended number of SKUs and calculates a threshold value by using the following equation 2, for example.

Threshold value=1÷Adopted number of SKUs (Equation 2)

In the case where the variability rate exceeds the threshold value calculated by using the above equation 2, the recommended SKU number calculation unit 11 corrects the calculated number of SKUs according to the variability rate. Specifically, in the case where the variability rate of the recommended number of SKUs increases and exceeds the first threshold value, the recommended SKU number calculation unit 11 increases the recommended number of SKUs. In the case where the variability rate of the recommended number of SKUs decreases and exceeds the second threshold value, the recommended SKU number calculation unit 11 decreases the recommended number of SKUs. Incidentally, the threshold value calculated by using the above equation 2 may be set for either of the first and second threshold values.

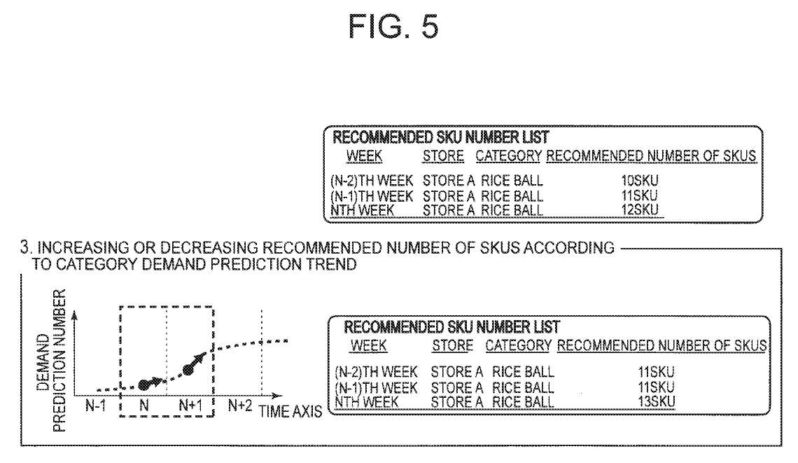

FIG. 5 is an explanatory diagram illustrating another example of processing of correcting the recommended number of SKUs. First, the recommended SKU number calculation unit 11 acquires the demand prediction number of the week (Nth week) for determining the recommended number of SKUs. Furthermore, the recommended SKU number calculation unit 11 acquires the demand prediction number of the (N+1)th week. Subsequently, the recommended SKU number calculation unit 11 calculates the variability rate of the demand prediction number of the Nth and (N+1)th weeks by using, for example, the above equation 1.

Since a demand trend indicated by a dotted line is predicted in the example illustrated in FIG. 5, the recommended SKU number calculation unit 11 may acquire the demand prediction numbers of the Nth and (N+1)th weeks to calculate a future demand prediction trend. Incidentally, the upper and lower limit values of the recommended number of SKUs may be previously provided to prevent the recommended number of SKUs from being radically corrected.

Since the recommended SKU number calculation unit 11 corrects the recommended number of SKUs on the basis of the demand prediction trend in this manner, the trend of the demand prediction is reflected by the recommended number of SKUs. This enables a reduction in the manipulations of correcting the adopted number of SKUs on the store side.

For example, the demand for seasonal products or the like may change abruptly. Since the recommended SKU number calculation unit 11 is able to previously correct the recommended number of SKUs on the basis of a demand prediction in this exemplary embodiment, each store is able to follow the change.

Incidentally, the recommended SKU number calculation unit 11 may correct the recommended number of SKUs on the basis of only one of the store adoption results tendency and the demand prediction trend or may correct the recommended number of SKUs on the basis of both of the tendency and the trend. In addition, the recommended number of SKUs may be corrected in an arbitrary order. Specifically, the recommended SKU number calculation unit 11 may carry out the correction based on the store adoption results tendency before the correction based on the demand prediction trend or may carry out the correction based on the demand prediction trend before the correction based on the store adoption results tendency.

The recommended SKU number calculation unit 11 determines the recommended number of SKUs and thereupon prorates the recommended number of SKUs for each product lineup section. The rate by which the prorating is performed is predetermined for each product lineup section. In this exemplary embodiment, there are set up three types of product lineup sections: “new product,” “sales order product,” and “repetition order product.” The product lineup section classification method, however, is not limited thereto and the sections to be set up are not limited to three types of sections.

The term “new product” in the product lineup section means a product to be added to the SKUs anew. The term “sales order product” means a product for a target of product lineup determination in the order of sales monetary amount. The “sales order product” includes both of a product having sales results in the past and a product having no sales results in the past. The term “repetition order product” in the product lineup section means a product selected for a product lineup for regular customers (repeat users).

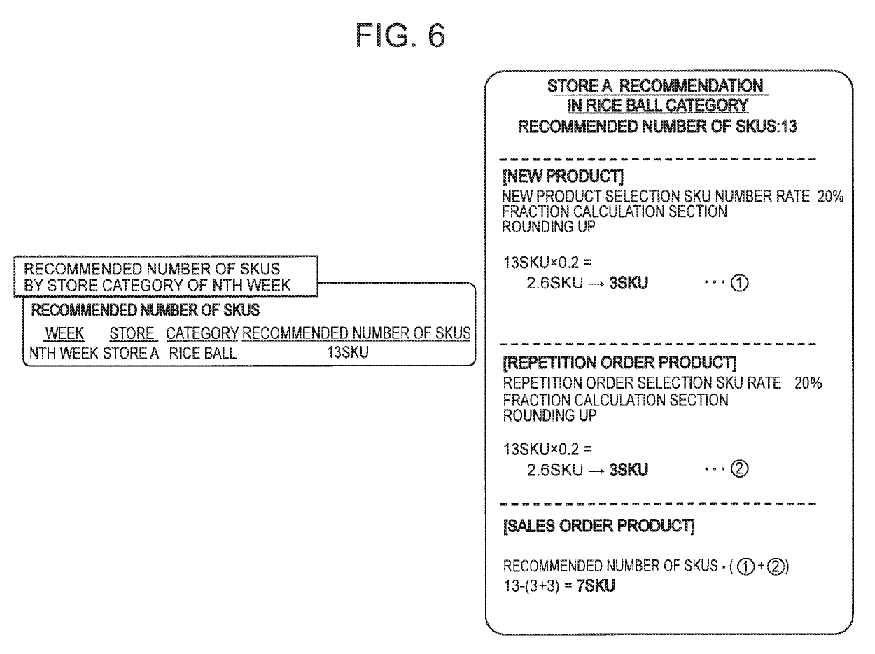

FIG. 6 is an explanatory diagram illustrating an example of processing of calculating the recommended number of SKUs for each product lineup section. For example, the recommended number of SKUs for a rice ball category of store A is assumed to be determined as 13. Moreover, the pro rata rates of “new product,” “sales order product,” and “repetition order product” are assumed to be predetermined as 20%, 60%, and 20%, respectively.

First, the recommended SKU number calculation unit 11 calculates the recommended number of SKUs for the new product. Specifically, the recommended SKU number calculation unit 11 multiplies the pro rata rate of “new product” by the recommended number of SKUs to calculate the recommended number of SKUs for the new product (hereinafter, referred to as “new product selection SKU number”). A way of handling of values after the decimal point (any one of rounding up, rounding down, and rounding off) may be previously determined.

In the example illustrated in FIG. 6, it is determined that a calculation is performed by rounding up a value. Therefore, the recommended SKU number calculation unit 11 calculates 13×0.2=2.6 and determines the new product selection SKU number to be 3.

The recommended SKU number calculation unit 11 then compares the calculated recommended number of SKUs α for the new product with the number of SKUs for the new product of the Nth week. If the calculated recommended number of SKUs α for the new product is greater than the number of SKUs for the new product of the Nth week (α>the number of SKUs for the new product), the recommended SKU number calculation unit 11 determines the number of SKUs for the new product as the new product selection SKU number. On the other hand, if the calculated recommended number of SKUs α for the new product is equal to or less than the number of SKUs for the new product of the Nth week (α≤the number of SKUs for the new product), the recommended SKU number calculation unit 11 determines α as the new product selection SKU number.

Subsequently, the recommended SKU number calculation unit 11 calculates the recommended number of SKUs for the repetition order product. Specifically, similarly to the case of “new product,” the recommended SKU number calculation unit 11 calculates the recommended number of SKUs for the repetition order product (hereinafter, referred to as “repetition order product selection SKU number”) by multiplying the pro rata rate of “repetition order product” by the recommended number of SKUs.

In the example illustrated in FIG. 6, similarly to the case of the new product, the recommended SKU number calculation unit 11 calculates 13×0.2=2.6 and determines the repetition order product selection SKU number as 3.

Subsequently, the recommended SKU number calculation unit 11 calculates the recommended number of SKUs for the sales order product. The recommended SKU number calculation unit 11 calculates the recommended number of SKUs for the sales order product by subtracting the new product selection SKU number and the repetition order product selection SKU number, which have already been obtained, from the recommended number of SKUs.

In the example illustrated in FIG. 6, the recommended SKU number calculation unit 11 subtracts 3 as the new product selection SKU number and 3 as the repetition order product selection SKU number from 13 as the recommended number of SKUs to calculate the recommended number of SKUs for the sales order product to be 7.

The recommended product lineup determination unit 12 identifies target products for each product lineup section and calculates the scores of the identified products for each section. The recommended product lineup determination unit 12 calculates a new product score, a sales trend score, and a repetition degree score for each of the product lineup sections, “new product,” “sales order product,” and “repetition order product,” respectively.

First, the recommended product lineup determination unit 12 calculates the new product score. Specifically, the recommended product lineup determination unit 12 calculates the sales monetary amount configuration information of a single item for a new product orderable in the Nth week and calculates the new product score on the basis of the monetary amount indicated by the calculated configuration information.

The sales monetary amount configuration information may be, for example, a sales amount itself of a product or may be an amount obtained by multiplying a profit margin of a product by a sales amount. In addition, the sales monetary amount configuration information may be a sales monetary amount configuration rate, which is calculated by “the sales amount of a product/the sales amount of a target product group (for example, a product group in the same category).”

In the following description, there is illustrated a case where a sales monetary amount configuration rate is used as the sales monetary amount configuration information. Moreover, this exemplary embodiment will be described by giving an example of a case of predicting a sales monetary amount configuration rate of a single item of the product by using a prediction model (a single item sales monetary amount configuration rate prediction model). The prediction model to be used, however, is not limited to a model of predicting the single item sales monetary amount configuration rate, as long as the model is used to predict the aforementioned sales monetary amount configuration information. The single item sales monetary amount configuration rate prediction model is previously learned and prepared on the basis of data such as sales results, sales information, product characteristics, a calendar, store information, blackout date information, a weather forecast, and the like. For learning of the prediction model, an arbitrary method may be used.

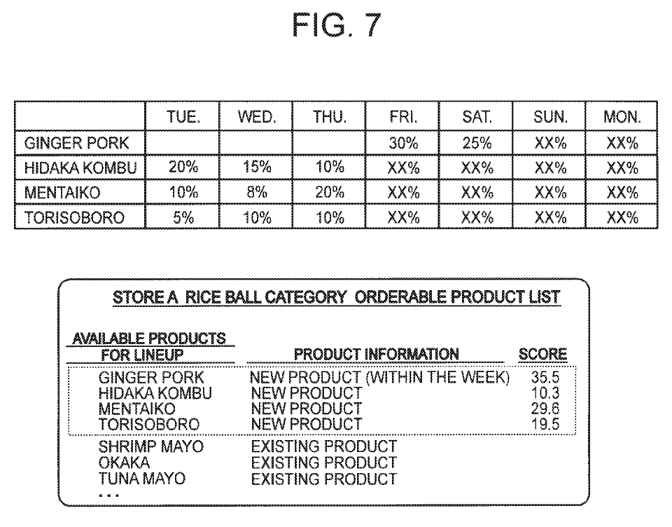

FIG. 7 is an explanatory diagram illustrating an example of processing of calculating a new product score. In the example illustrated in FIG. 7, the single item sales monetary amount configuration rate prediction model is assumed to predict a single item sales monetary amount configuration rate each day. First, the recommended product lineup determination unit 12 predicts a daily single item sales monetary amount configuration rate of the Nth week by using the single item sales monetary amount configuration rate prediction model. In the example illustrated in FIG. 7, it is assumed that new products of four types of rice balls such as “ginger pork (Buta Syougayaki),” “Hidaka Kombu (seaweed),” “Mentaiko (spicy cod roe),” and “Torisoboro (minced chicken)” are present and the diagram illustrates that “ginger pork” is offered for sale from Friday.

Subsequently, the recommended product lineup determination unit 12 calculates an average value of the single item sales monetary amount configuration rate for each product of the Nth week as a new product score. The example in FIG. 7 illustrates that the new product scores of the rice balls “ginger pork,” “Hidaka Kombu,” “Mentaiko,” and “Torisoboro” are calculated to be 35.5, 10.3, 29.6, and 19.5, respectively.

In this exemplary embodiment, the recommended product lineup determination unit 12 calculates scores on the basis of the sales monetary amount configuration rate, thereby preventing only a lot of inexpensive products from being selected.

Subsequently, the recommended product lineup determination unit 12 calculates sales trend scores. Specifically, the recommended product lineup determination unit 12 calculates the sales monetary amount configuration rate of each of products having sales results at the host store and products having no sales results at the host store for each store and then calculates a sales trend score on the basis of the calculated configuration rate. In the above, the term “product having no sales results” means a product having no sales results for a target period. Moreover, a store as a target of calculating the sales trend score (in other words, a store for which the product lineup is recommended) is sometimes referred to as “target store.”

First, the recommended product lineup determination unit 12 calculates the sales monetary amount configuration rate of a product having sales results at the host store. For the product having sales results at the host store (target store), past sales results (for example, sales monetary amount results by date, by store, and by product) is present. Therefore, the recommended product lineup determination unit 12 calculates the sales monetary amount configuration rate of the product having sales results at the target store (hereinafter, referred to as “first configuration rate”) as a sales trend score on the basis of the sales results of the target store for the predetermined past period. Since the first configuration rate indicates sales monetary amount configuration information, it can be referred to as “first configuration information.” Specifically, the recommended product lineup determination unit 12 calculates the sales monetary amount configuration rate for each day, each store, and each product on the basis of the most recent past actual values to calculate a daily average value. As target past actual values, sales monetary amounts of the last two weeks (the (N−2)th and (N−1)th weeks) may be used, for example.

Subsequently, the recommended product lineup determination unit 12 calculates the sales monetary amount configuration rate of the product having no sales results at the host store. For the product having no sales results at the host store (target store), any past sales results are not present. Therefore, the recommended product lineup determination unit 12 calculates a sales monetary amount configuration rate of the product having no sales results at the target store for a predetermined past period (hereinafter, referred to as “second configuration rate”) on the basis of a prediction model for predicting the sales monetary amount configuration rate of a single item of the product as a sales trend score. Incidentally, since the second configuration rate also indicates the sales monetary amount configuration information, it can be referred to as “second configuration information.” In this exemplary embodiment, the recommended product lineup determination unit 12 predicts a sales monetary amount configuration rate of a single item by using the prediction model used for calculating the new product score (a single item sales monetary amount configuration rate prediction model). Specifically, the recommended product lineup determination unit 12 predicts the sales monetary amount configuration rate for each day, each store, and each product and then calculates a daily average value.

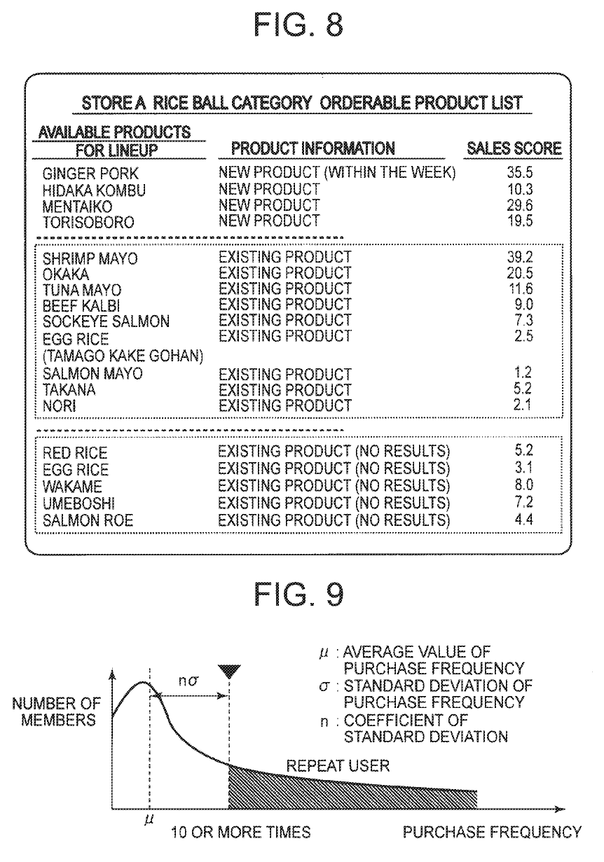

FIG. 8 is an explanatory diagram illustrating an example of a calculation result of a sales trend score. The products illustrated in the upper part of FIG. 8 are those having results at the host store, and the products in the lower part are those having no results. For the products in the upper part, the sales monetary amount configuration rates are calculated on the basis of past actual values. For the products in the lower part, the sales monetary amount configuration rates are calculated on the basis of the prediction model.

While a method of calculating the sales trend score depends on whether the product has results at the host store or has no results at the host store, the sales trend score indicates a sales monetary amount configuration rate in either case. Furthermore, generally the prediction model of a new product often includes the number of days elapsed from the sales start. Therefore, it can be said that the use of this prediction model also enables the prediction of a sales monetary amount in a period in which the trend is gradually stabilized from the start of selling the new product.

As described above, the recommended product lineup determination unit 12 calculates a sales monetary amount configuration rate independently of whether the product has sales results or not in this exemplary embodiment, by which recommended products is able to be compared with each other in the same scale.

Subsequently, the recommended product lineup determination unit 12 calculates a repetition degree score. First, the recommended product lineup determination unit 12 determines a repeat user for each category. In this exemplary embodiment, it is assumed that the storage unit 14 stores actual data in which a number uniquely identifiable by a customer (hereinafter, referred to as “customer number”) is associated with a product for sale.

The recommended product lineup determination unit 12 determines a regular customer evaluation threshold value from purchase frequencies for a past predetermined period of customers in each store. FIG. 9 is an explanatory diagram illustrating an example of a method of determining a repeat user. The recommended product lineup determination unit 12 determines the regular customer evaluation threshold value on the basis of, for example, an equation 3 illustrated below. Incidentally, n is a coefficient of the standard deviation and previously determined.

Regular customer evaluation threshold value=Purchase frequency average μ+n×Purchase frequency standard deviation σ (Equation 3)

In the example illustrated in FIG. 9, the recommended product lineup determination unit 12 determines the regular customer evaluation threshold value from a purchase frequency for a predetermined period (past four weeks) and identifies a customer having purchased a product with a frequency equal to or higher than a threshold value (for example, 10 or more times) as a repeat user.

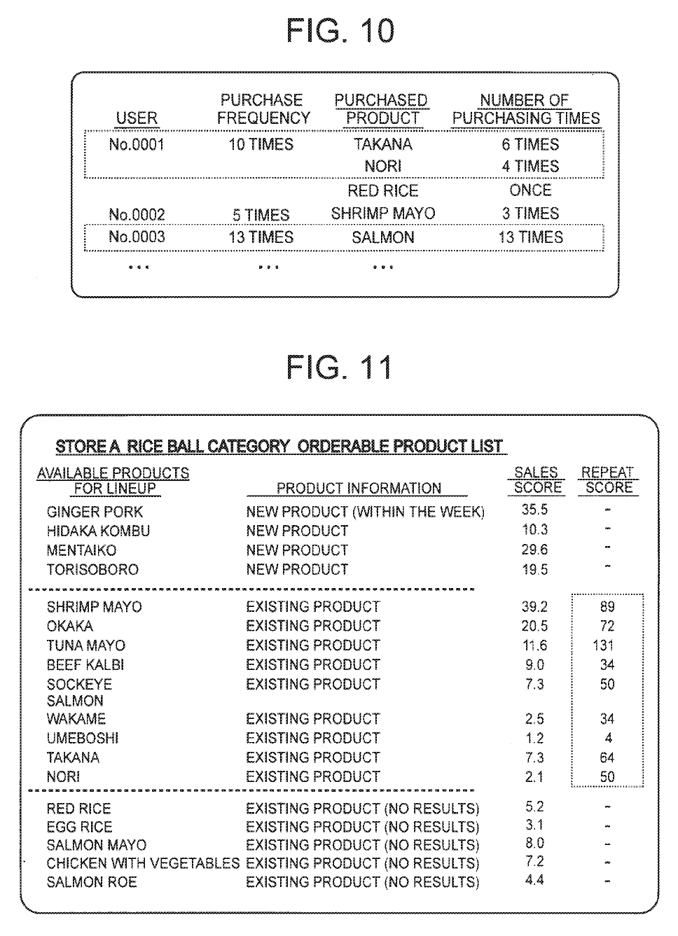

The recommended product lineup determination unit 12 then calculates the total number of times the determined repeat user purchased the product for the past predetermined period, as a repetition degree score. FIG. 10 is an explanatory diagram illustrating an example of processing of identifying a repeat user. The example in FIG. 10 illustrates that, in the case where a customer (user) whose purchase frequency is 10 or more times is identified as a repeat user, the number of times the user purchased the product has been considered to be a target of score calculation. Moreover, FIG. 11 illustrates an example in which the calculated repeat scores are associated with the sales scores of existing products.

The recommended product lineup determination unit 12 selects products for lineup for each section on the basis of the calculated scores (the new product score, the sales trend score, and the repetition degree score). In the case of preventing new products from being removed from a lineup, first, the recommended product lineup determination unit 12 selects the new product selection SKU number of new products in descending order of the new product score.

Incidentally, in the case where new products are scheduled to be added in the middle of a target period and where the products are high-ranking in the new product score, the recommended product lineup determination unit 12 may additionally select the new products to be added even if the new product selection SKU number is thereby exceeded.

Subsequently, the recommended product lineup determination unit 12 selects new products of the recommended number of SKUs of the sales order products in the order of the sales trend score. Specifically, the recommended product lineup determination unit 12 selects the specified number (i.e., the recommended number of SKUs of the sales order products) of products, in descending order of the sales monetary amount configuration rate, from among the products for which the first configuration rates are calculated (i.e., products having sales results for a predetermined period) and products for which the second configuration rates are calculated (i.e., products having no sales results for a predetermined period). In other words, it can also be said that the recommended product lineup determination unit 12 selects the specified number of products, in descending order of monetary amount indicated by the sales monetary amount configuration information, from among the products for which the first configuration information is calculated and products for which the second configuration information is calculated.

The sales trend scores for products having results at the host store are calculated separately from those for products having no results at the host store, and it can be said that the sales trend scores based on results are more reliable. Therefore, the recommended product lineup determination unit 12, first, selects targets of product lineup from among the products having sales results at the host store. In other words, the recommended product lineup determination unit 12 selects products, in descending order of the sales monetary amount configuration rate, from among the products for which the first configuration rate has been calculated.

In this selection, the recommended product lineup determination unit 12 may preferentially select products having sales results to some extent to prevent only products having results at the host store from being selected. The recommended product lineup determination unit 12 may, first, select only products, for example, each having a sales monetary amount configuration rate equal to or higher than an average (specifically, 1÷the number of SKUs having sales results at the host store).

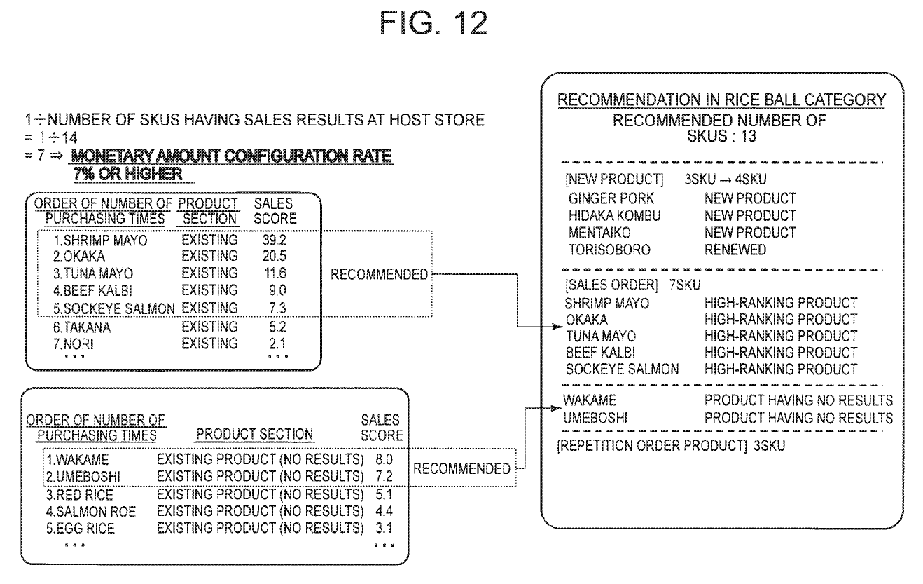

FIG. 12 is an explanatory diagram illustrating an example of processing of selecting sales order products. For example, in the case of 14 as the number of SKUs sold at the host store, the recommended product lineup determination unit 12 may select products whose monetary amount configuration rate is 7% or higher as high-ranking products on the basis of a calculation result of 1÷14×100≈7%. In this case, in the example illustrated in FIG. 12, the products ranked in the top five in the sales score are selected as high-ranking products from among the products having sales results at the host store.

After selecting the products having sales results at the host store, the recommended product lineup determination unit 12 then selects product lineup targets from among the products having no sales results at the host store. In other words, in the case where the number of products whose sales monetary amount configuration rate of a target store is equal to or higher than an average is less than the specified number among the products for which the first configuration rate is calculated, the recommended product lineup determination unit 12 selects product lineup targets from among the products having no sales results at the host store.

In this selection, the recommended product lineup determination unit 12 may preferentially select products predicted to be sold to some extent to prevent products too low in sales results from being selected. For example, similarly to the products having sales results at the host store, the recommended product lineup determination unit 12 may select only products whose predicted sales monetary amount configuration rate is equal to or higher than an average (specifically, 1÷the number of SKUs having sales results at the host store). In the example illustrated in FIG. 12, products ranked in the top two in the sales score are selected from among the products having no sales results at the host store.

It is also conceivable that the number of selected products is less than the recommended number of SKUs of the sales order products. As described above, while a method of calculating the sales trend score depends on whether the product has results at the host store or has no results at the host store, the sales trend score indicates a sales monetary amount configuration rate in either case. Accordingly, the recommended product lineup determination unit 12 selects products ranked high in the sales score out of products not selected among the products having sales results at the host store and the products having no sales results at the host store until the number of selected products reaches the recommended number of SKUs of the sales order products. In other words, in the case where the number of products whose sales monetary amount configuration rate of the target store is equal to or higher than an average is less than the specified number, the recommended product lineup determination unit 12 selects products in descending order of the first configuration rate or the second configuration rate out of products, which have not been selected yet.

For example, in the example illustrated in FIG. 12, products ranked sixth or lower in the sales score are not selected among the products having sales results at the host store. Similarly, products ranked third or lower in the sales score are not selected among the products having no sales results at the host store. Therefore, the recommended product lineup determination unit 12 selects products ranked high in the sales score in order among the products which have not been selected yet. In the example illustrating in FIG. 12, a product ranked sixth in the sales score (Takana [pickled mustard leaf] rice ball) is selected first among the products having sales results at the host store and then a product ranked third in the sales score (red rice ball) is selected among the products having no sales results at the host store, and so on.

Subsequently, the recommended product lineup determination unit 12 selects the products of the recommended number of SKUs of the repetition order products in the order of repetition degree score. Specifically, the recommended product lineup determination unit 12 selects products, in descending order of the repetition degree score, from among the products not having been selected yet. Due to the characteristics of the sections, even if generally-unpopular products are included, products are required to be selected for a lineup intended for regular customers and therefore repetition order products are selected last.

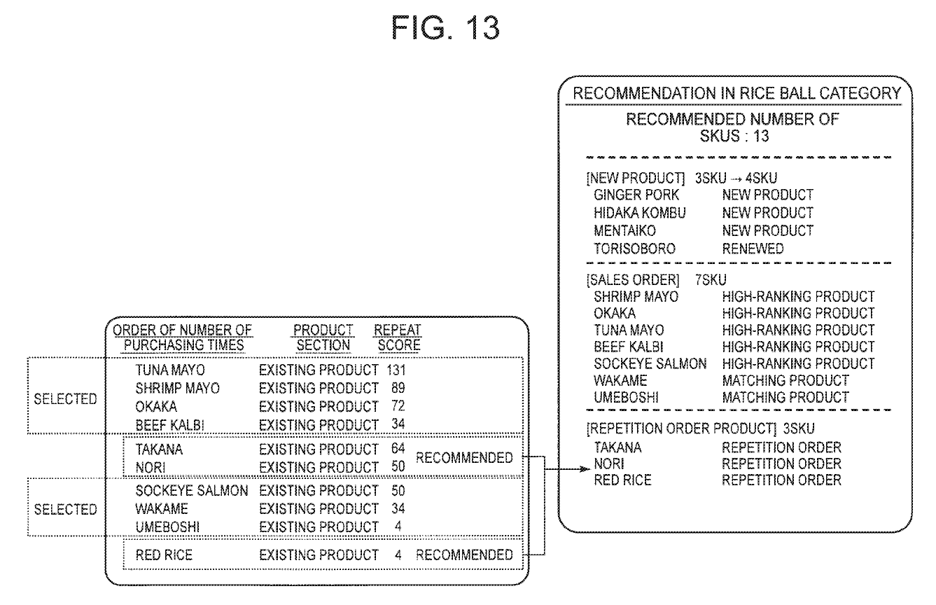

FIG. 13 is an explanatory diagram illustrating an example of processing of selecting repetition order products. The example in FIG. 13 illustrates that products are selected in descending order of the high repetition degree score, namely “Takana (pickled mustard leaf),” “Nori (dried laver),” and “red rice” from among the products not having been selected yet.

In addition, in the case where a product included as a product lineup target is not selected, the recommended product lineup determination unit 12 may intentionally add the product in response to a user's or any other's instruction to revise the recommended number of SKUs. Similarly, in the case where a product not required to be included as a product lineup target is selected, the recommended product lineup determination unit 12 may intentionally delete the product in response to a user's or any other's instruction to revise the recommended number of SKUs.

The transmission unit 13 transmits the calculated recommended number of SKUs for each store and the selected recommended product lineup list to the corresponding store terminal 20.

The recommended SKU number calculation unit 11, the recommended product lineup determination unit 12, and the transmission unit 13 are implemented by the CPU of a computer that acts according to programs (an inventory management program and a product lineup recommendation program). For example, the programs may be stored in the storage unit 14 and the CPU may read the programs to act as the recommended SKU number calculation unit 11, the recommended product lineup determination unit 12, and the transmission unit 13 according to the programs. Furthermore, each of the recommended SKU number calculation unit 11, the recommended product lineup determination unit 12, and the transmission unit 13 may be implemented by dedicated hardware.

Moreover, in this exemplary embodiment, description has been made on the case where the recommended product lineup determination unit 12 performs the process of calculating the first configuration rate, the process of calculating the second configuration rate, and the process of selecting products. These processes may be implemented by respective means independent of each other (a first configuration rate calculation unit, a second configuration rate calculation unit, and a product selection unit).

The store terminal 20 includes a product lineup determination unit 21, a transmission unit 22, and a storage unit 23. The storage unit 23 is implemented by, for example, a magnetic disk or the like.

The product lineup determination unit 21 determines a product lineup to be adopted on the basis of the transmitted recommended number of SKUs and the recommended product lineup list and additionally determines the recommended number of SKUs. Specifically, the product lineup determination unit 21 determines the products to be adopted according to an instruction of a person in charge or the like of each store and determines the final adopted number of SKUs. Moreover, the product lineup determination unit 21 may store the determined adopted number of SKUs and the history of the adopted product in the storage unit 23.

The transmission unit 22 transmits the adopted number of SKUs determined on the store side to the headquarters server 10. In other words, the transmission unit 22 sends back the adopted number of SKUs determined in each store in response to the transmitted recommended number of SKUs to the headquarters server 10.

The product lineup determination unit 21 and the transmission unit 22 are implemented by the CPU of the computer that acts according to a program (a product lineup determination program). For example, the program may be stored in the storage unit 23 and the CPU may read the program and then act as the product lineup determination unit 21 and the transmission unit 22 according to the program. Moreover, each of the product lineup determination unit 21 and the transmission unit 22 may be implemented by dedicated hardware.

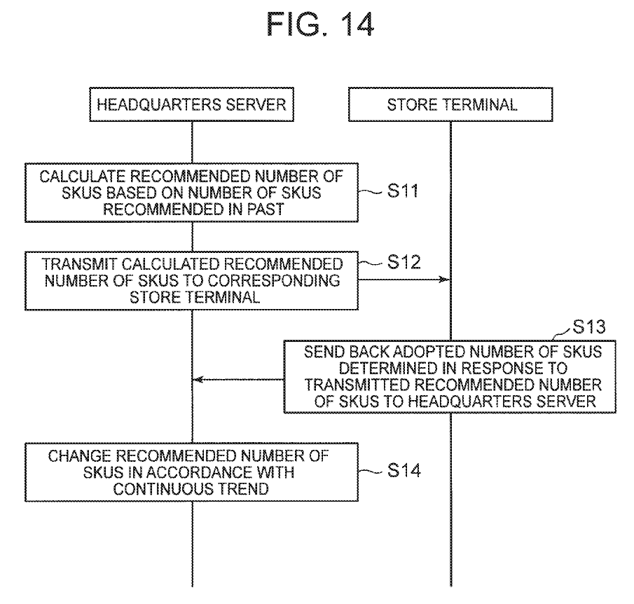

Subsequently, the actions of the inventory management system of this exemplary embodiment will be described. FIG. 14 is a sequence diagram illustrating an example of action of an inventory management system of this exemplary embodiment. The recommended SKU number calculation unit 11 of the headquarters server 10 calculates the recommended number of SKUs on the basis of the number of SKUs recommended in the past (step S11). The transmission unit 13 of the headquarters server 10 transmits the calculated recommended number of SKUs to the corresponding store terminal 20 (step S12).

The transmission unit 22 of the store terminal 20 sends back the adopted number of SKUs determined in each store in response to the transmitted recommended number of SKUs to the headquarters server 10 (step S13). In the case where the adopted number of SKUs sent back in response to the transmitted recommended number of SKUs changes continuously and in a consistent trend, the recommended SKU number calculation unit 11 of the headquarters server 10 changes the recommended number of SKUs in accordance with the trend (step S14). Hereinafter, the processes of step S12 and subsequent steps are repeated.

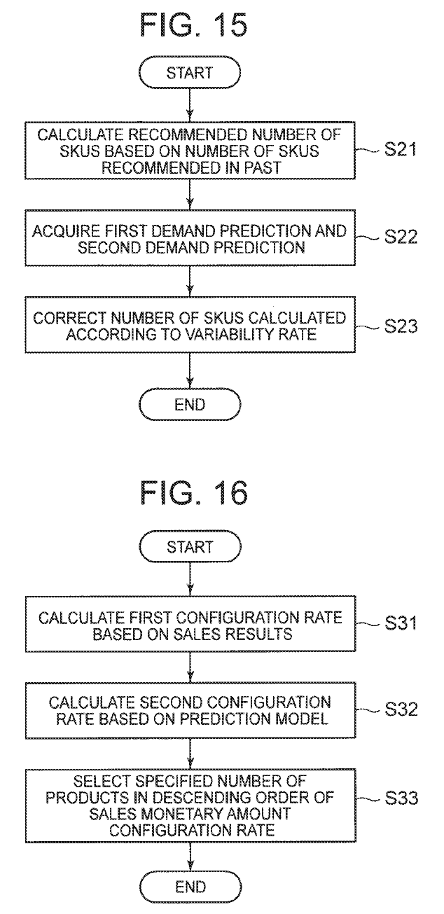

FIG. 15 is a flowchart illustrating an example of processing of correcting the number of SKUs calculated according to a variability rate of demand prediction. The recommended SKU number calculation unit 11 of the headquarters server 10 calculates the recommended number of SKUs on the basis of the number of SKUs recommended in the past (step S21). Furthermore, the recommended SKU number calculation unit 11 acquires the demand prediction of the Nth week (first demand prediction) and the demand prediction of the (N+1)th week (second demand prediction) (step S22).

Furthermore, in the case where the variability rate of the second demand prediction relative to the first demand prediction exceeds a threshold value, the recommended SKU number calculation unit 11 corrects the number of SKUs calculated according to the variability rate (step S23). Incidentally, the processes of steps S22 and S23 may be performed before or after the step S14 of FIG. 14.

FIG. 16 is a flowchart illustrating an example of action of determining a recommended product lineup. The recommended product lineup determination unit 12 calculates the first configuration rate on the basis of sales results of a target store for a predetermined past period (step S31). Moreover, the recommended product lineup determination unit 12 calculates the second configuration rate on the basis of a prediction model for predicting the sales monetary amount configuration rate of a single product item (step S32). Thereafter, the recommended product lineup determination unit 12 selects a specified number of products, in descending order of the sales monetary amount configuration rate, from among the products for which the first configuration rate is calculated and the products for which the second configuration rate is calculated (step S33).

As described hereinabove, in this exemplary embodiment, the recommended SKU number calculation unit 11 calculates the recommended number of SKUs on the basis of the number of SKUs recommended in the past and the transmission unit 13 transmits the calculated recommended number of SKUs to the store terminal. In addition, in the case where the adopted number of SKUs sent back from a store in response to the transmitted recommended number of SKUs changes continuously and in a consistent trend, the recommended SKU number calculation unit 11 changes the recommended number of SKUs for the store in accordance with the trend.

According to the above configuration, an appropriate recommended number of SKUs managed by each store is able to be determined in a business form in which the headquarters manages respective stores. Moreover, the recommended SKU number calculation unit 11 makes decision on the basis of a continuous trend, thereby preventing the recommended number of SKUs from being determined due to an irregular variation.

Moreover, in this exemplary embodiment, the recommended SKU number calculation unit 11 acquires the first demand prediction of the Nth week and the second demand prediction of the (N+1)th week, and in the case where the degree of variation (for example, variability rate) in the second demand prediction relative to the first demand prediction exceeds a threshold value, the recommended SKU number calculation unit 11 corrects the calculated number of SKUs in accordance with the degree.

Also according to this configuration, an appropriate recommended number of SKUs managed by each store is able to be determined in the business form in which the headquarters manages respective stores.

Moreover, in this exemplary embodiment, the recommended product lineup determination unit 12 calculates the first configuration information (the first configuration rate) on the basis of sales results of a target store for a predetermined past period and calculates the second configuration information (the second configuration rate) on the basis of a prediction model of predicting a sales monetary amount configuration rate of a single product item. The recommended product lineup determination unit 12 then selects a specified number of products, in descending order of monetary amount indicated by the sales monetary amount configuration information (concretely, in descending order of configuration rate), from among products for which the first configuration rate is calculated and products for which the second configuration rate is calculated.

According to the configuration, a product lineup target is able to be recommended independently of the presence or absence of the sales results, with prioritized products having no sales results.

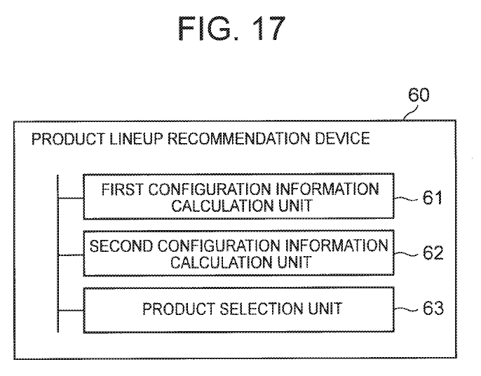

The following describes the outline of the present invention. FIG. 17 is a block diagram illustrating an outline of a product lineup recommendation device according to the present invention. A product lineup recommendation device 60 according to the present invention includes: a first configuration information calculation unit 61 (for example, a recommended product lineup determination unit 12) that calculates, on the basis of sales results for a target store during a predetermined past period (for example, (N−1)th and (N−2)th weeks), first configuration information, which is sales monetary amount configuration information for products having sales results at the target store; a second configuration information calculation unit 62 (for example, the recommended product lineup determination unit 12) that calculates second configuration information, which is sales monetary amount configuration information for products having no sales results at the target store during the above period on the basis of a prediction model that predicts sales monetary amount configuration information for single product items; and a product selection unit 63 (for example, the recommended product lineup determination unit 12) that selects a specified number of products from among products for which the first configuration information is calculated and products for which the second configuration information is calculated, in descending order of monetary amount indicated by the sales monetary amount configuration information.

According to the above configuration, product lineup targets is able to be recommended independently of the presence or absence of sales results, with prioritized products having no sales results. In other words, a sales monetary amount configuration rate is calculated for products having sales results and for products having no sales results, and therefore recommended products are able to be compared with each other in the same scale. Moreover, products are selected in the order of sales monetary amount configuration rate, thereby preventing only a lot of inexpensive products from being selected.

Furthermore, the product selection unit 63 may select products, in descending order of monetary amount indicated by the sales monetary amount configuration information, from among the products for which the first configuration information is calculated and then select products, in descending order of monetary amount indicated by sales monetary amount configuration information, from among the products for which the second configuration information is calculated, after the selection of the products for which the first configuration information is calculated.

Furthermore, the product selection unit 63 may select products having an average or higher monetary amount indicated by the sales monetary amount configuration information for the target store from among the products for which the first configuration information is calculated. According to this configuration, selection of only products having results at the host store is able to be prevented.

Moreover, in the case where the number of products having an average or higher monetary amount indicated by the sales monetary amount configuration information for the target store is less than the specified number among the products for which the first configuration information is calculated, the product selection unit 63 may select products having an average or higher monetary amount indicated by the sales monetary amount configuration information for the target store from among the products for which the second configuration information is calculated. According to this configuration, selection of products having too low sales results is prevented.

Furthermore, in the case where the number of products having an average or higher monetary amount indicated by the sales monetary amount configuration information for the target store is less than the specified number, the product selection unit 63 may select products, in descending order of monetary amount indicated by the first configuration information or the second configuration information, from among the products not selected.

Specifically, the first configuration information calculation unit 61 may calculate sales monetary amount configuration rates of products as first configuration information and the second configuration information calculation unit 62 may calculate second configuration information on the basis of a prediction model that predicts the sales monetary amount configuration rates of single product items.

Although the present invention has been described with reference to the exemplary embodiments and examples hereinabove, the present invention is not limited thereto. A variety of changes, which can be understood by those skilled in the art, may be made in the configuration and details of the present invention within the scope thereof.

This application claims priority to Japanese Patent Application No. 2016-183725 filed on Sep. 21, 2016, and the entire disclosure thereof is hereby incorporated herein by reference.

### REFERENCE SIGNS LIST

10 Headquarters server
11 Recommended SKU number calculation unit
12 Recommended product lineup determination unit
13 Transmission unit
14 Storage unit
20 Store terminal
21 Product lineup determination unit
22 Transmission unit
23 Storage unit
100 Inventory management system

1. A product lineup recommendation device comprising:
a hardware including a processor;
a first configuration information calculation unit, implemented by the processor, that calculates, on the basis of sales results for a target store during a predetermined past period, first configuration information, which is sales monetary amount configuration information for products having sales results at the target store;
a second configuration information calculation unit, implemented by the processor, that calculates second configuration information, which is sales monetary amount configuration information for products having no sales results at the target store during the period on the basis of a prediction model that predicts sales monetary amount configuration information for single product items; and
a product selection unit, implemented by the processor, that selects a specified number of products from among products for which the first configuration information is calculated and products for which the second configuration information is calculated, in descending order of monetary amount indicated by the sales monetary amount configuration information.

2. The product lineup recommendation device according to claim 1, wherein the product selection unit selects products, in descending order of monetary amount indicated by the sales monetary amount configuration information, from among the products for which the first configuration information is calculated and then selects products, in descending order of monetary amount indicated by the sales monetary amount configuration information, from among the products for which the second configuration information is calculated, after the selection of the products for which the first configuration information is calculated.

3. The product lineup recommendation device according to claim 1, wherein the product selection unit selects products having an average or higher monetary amount indicated by the sales monetary amount configuration information for the target store from among the products for which the first configuration information is calculated.

4. The product lineup recommendation device according to claim 3, wherein, in the case where the number of products having an average or higher monetary amount indicated by the sales monetary amount configuration information for the target store is less than the specified number among the products for which the first configuration information is calculated, the product selection unit selects products having an average or higher monetary amount indicated by the sales monetary amount configuration information for the target store from among the products for which the second configuration information is calculated.

5. The product lineup recommendation device according to claim 4, wherein, in the case where the number of products having an average or higher monetary amount indicated by the sales monetary amount configuration information for the target store is less than the specified number, the product selection unit selects products, in descending order of monetary amount indicated by the first configuration information or the second configuration information, from among the products not selected.

6. The product lineup recommendation device according to claim 1, wherein:
the first configuration information calculation unit calculates sales monetary amount configuration rates of products as first configuration information; and
the second configuration information calculation unit calculates second configuration information on the basis of a prediction model that predicts the sales monetary amount configuration rates of single product items.

7. A product lineup recommendation method comprising:
calculating, on the basis of sales results for a target store during a predetermined past period, first configuration information, which is sales monetary amount configuration information for products having sales results at the target store;
calculating second configuration information, which is sales monetary amount configuration information for products having no sales results at the target store during the period on the basis of a prediction model that predicts sales monetary amount configuration information for single product items; and
selecting a specified number of products from among products for which the first configuration information is calculated and products for which the second configuration information is calculated, in descending order of monetary amount indicated by the sales monetary amount configuration information.

8. The product lineup recommendation method according to claim 7, wherein products are selected in descending order of monetary amount indicated by the sales monetary amount configuration information from among the products for which the first configuration information is calculated and then products are selected in descending order of monetary amount indicated by the sales monetary amount configuration information from among the products for which the second configuration information is calculated after the selection of the products for which the first configuration information is calculated.

9. A non-transitory computer readable information recording medium storing a product lineup recommendation program, when executed by a processor, that performs a method for:
calculating, on the basis of sales results for a target store during a predetermined past period, first configuration information, which is sales monetary amount configuration information for products having sales results at the target store;
calculating second configuration information, which is sales monetary amount configuration information for products having no sales results at the target store during the period on the basis of a prediction model that predicts sales monetary amount configuration information for single product items; and
selecting a specified number of products from among products for which the first configuration information is calculated and products for which the second configuration information is calculated, in descending order of monetary amount indicated by the sales monetary amount configuration information.

10. The non-transitory computer readable information recording medium according to claim 9, wherein products are selected in descending order of monetary amount indicated by the sales monetary amount configuration information from among the products for which the first configuration information is calculated and then products are selected in descending order of monetary amount indicated by the sales monetary amount configuration information from among the products for which the second configuration information is calculated after the selection of the products for which the first configuration information is calculated.
